(19) United States
(12) Patent Application Publication
(10) Pub. No.: US 2014/0301218 A1
(43) Pub. Date: Oct. 9, 2014

(54) STATISTICAL ANALYSIS AND PROMPTING METHOD AND SYSTEM FOR MOBILE TERMINAL INTERNET TRAFFIC

(71) Applicant: Beijing Netqin Technology Co., Ltd., Beijing (CN)

(72) Inventors: Chao Luo, Beijing (CN); Yipeng Zhang, Beijing (CN); Shihong Zou, Beijing (CN); Yu Lin, Beijing (CN)

(21) Appl. No.: 14/129,751

(22) PCT Filed: Dec. 26, 2012
(86) PCT No.: PCT/CN2012/087521

§ 371 Date: Dec. 27, 2013

(30) Foreign Application Priority Data
Dec. 29, 2011 (CN) 201110451912

(51) Int. Cl. H04W 24/08; H04L 12/26

(52) U.S. Cl. CPC H04W 24/08; H04L 43/062
USPC 370/252

(57) ABSTRACT

The present disclosure provides a statistical analysis and prompting method and system for mobile terminal Internet traffic. The method comprises: a mobile terminal obtaining mobile terminal Internet traffic usage data from an operator in real time; monitoring local mobile terminal Internet traffic usage data in real time; performing synchronization processing on the mobile terminal Internet traffic usage data obtained from the operator and the local mobile terminal Internet traffic usage data monitored in real time, to obtain real-time Internet traffic usage data; using the real-time Internet traffic usage data to calculate an estimated number of days with the traffic still being available, and prompting information regarding the estimated number of days to the user in real time. The effects of the present disclosure comprise that trend analysis can be performed on the data on the Internet traffic already used by the mobile terminal to obtain an estimated number of days for the remaining traffic, and the result can be prompted to the user in real time, so that the user can know the availability of the traffic in time, thereby achieving the objective of reasonably allocating and fully taking advantage of traffic resources.

### TECHNICAL FIELD

The present disclosure relates to the mobile communication field, and particularly, to a statistical analysis and prompting method and system for mobile terminal Internet traffic.

### BACKGROUND

With development of 3G and wireless network communication technologies, it becomes popular to use a mobile communication device (such as mobile phones, tablets, etc.) for Internet surfing. There are different levels of Internet traffic packages for requirements of different groups of users. For example, a user may subscribe a monthly payable service for Internet surfing which allows a total traffic of 100M. However, traffic exceeding 100M will be charged expensively. Such “sky-high price” for Internet surfing on a mobile phone is usually exposed by media. Thus, more and more users want to inquire Internet traffic so as to utilize it properly and save cost. Generally, a user may inquire Internet traffic by logging on websites of an operator, dialing hotlines, sending a short message, and the like. However, these approaches are troublesome. Moreover, Internet traffic may not be inquired in real time due to delay of data update in selling areas. Furthermore, users may be remiss of inquiring Internet traffic due to some reasons, resulting in unnecessary loss. Accordingly, some mobile phones have a function of inquiring Internet traffic integrated thereon. In particular, an Internet traffic statistics module is arranged on a mobile phone, which module achieves a function of inquiring Internet traffic by counting the Internet traffic. As a result, the user of the mobile phone can check usage of the Internet traffic.

There are some methods for Internet traffic statistics and inquiring in prior art. For example, a Chinese patent application No. 200910082133.7, filed on Apr. 16, 2009 and titled “Method for network traffic statistics in mobile phone client” discloses a method in mobile phone client for network traffic statistics and inquiring, comprising the steps of: 1) the mobile phone client adding a function of network traffic statistics to a communication module; 2) the mobile phone client adding an interface for checking the traffic so as to support checking the traffic month by month. By using such a method, a user may perform a statistics of Internet traffic and check the statistics result via a mobile phone, without inquiring the usage of Internet traffic from an operator. However, such approach lacks a mechanism of real time prompting. If the user does not check the statistics result for a long time, he/she cannot determine whether the used traffic has exceeded an available range. Therefore, a potential loss may arise.

There are technologies for prompting real time remaining traffic information in prior art. For example, a Chinese patent application No. 201010545900.6, filed on Nov. 16, 2010 and titled “Method and system for prompting remaining Internet traffic in a mobile phone” discloses a method in mobile phone client for prompting remaining Internet traffic, comprising the steps of: S1. the mobile phone inquiring Internet traffic usage data from selling areas; S2. the mobile phone monitoring local mobile phone Internet traffic usage data; S3. the mobile phone performing an additive process of the Internet traffic usage data from selling areas and the local mobile phone Internet traffic usage data, getting rid of free traffic, obtaining real time remaining traffic within package, and comparing the real time remaining traffic within package with a set minimum threshold value; S4. if the real time remaining traffic within package is less than or equal to the set minimum threshold value, prompting the real time remaining traffic within package to the user via the mobile phone. In this method, the user needs to set a minimum threshold value of Internet traffic for the mobile phone. Only if the real time remaining traffic within package is less than or equal to the set minimum threshold value, the mobile phone prompts the real time remaining traffic within package to the user. Therefore, the user cannot understand Internet traffic usage timely before the mobile phone sending out the prompt. As a result, the user cannot allocate and utilize Internet traffic resources properly.

In the prior art methods, Internet traffic for a mobile phone can be calculated and remaining traffic information can be inquired and displayed. However, these approaches lack a mechanism of analysis of traffic data usage trend and real time prompting for analysis result. Moreover, the prior art methods can only inquire a total value of traffic for a single day or current month. That is, the prior art methods cannot inquire traffic usage for each application. As a result, improvements to statistical analysis and inquiring of traffic data are desired.

### SUMMARY OF THE INVENTION

The present disclosure provides a statistical analysis and prompting method for mobile terminal Internet traffic, which aims at solving the problem in the prior art that there is no mechanism of analysis of traffic data usage trend and real time prompting for analysis result, such that the user cannot understand traffic usage timely and allocate and utilize Internet traffic resources properly.

One solution of the present disclosure relates to a statistical analysis and prompting method for mobile terminal Internet traffic, comprising the steps of:

a) a mobile terminal obtaining mobile terminal Internet traffic usage data from an operator in real time;

b) the mobile terminal monitoring local mobile terminal Internet traffic usage data in real time;

c) the mobile terminal performing synchronization processing on the mobile terminal Internet traffic usage data obtained from the operator and the local mobile terminal Internet traffic usage data monitored in real time, to obtain real-time Internet traffic usage data;

d) the mobile terminal using the real-time Internet traffic usage data to calculate an estimated number of days with the traffic still being available, and prompting information regarding the estimated number of days to the user in real time.

According to an aspect of the present disclosure, the mobile terminal Internet traffic usage data comprises a value indicating total traffic in a user package, a value indicating used traffic, a value indicating remaining traffic, and a settlement time.

According to an aspect of the present disclosure, the step a) comprises the mobile terminal obtaining a short message including the mobile terminal Internet traffic usage data returned from the operator by sending a short message to the operator.

According to an aspect of the present disclosure, further comprising: the mobile terminal extracting the mobile terminal Internet traffic usage data from text of the short message by using information extraction technology.

According to an aspect of the present disclosure, the mobile terminal obtaining the short message returned from the operator and submitting the short message to a server, and the server extracting the mobile terminal Internet traffic usage data from text of the short message by using information extraction technology, and returning the mobile terminal Internet traffic usage data to the mobile terminal.

According to an aspect of the present disclosure, the step b) comprises the mobile terminal monitoring mobile terminal Internet traffic usage data in real time by accessing a local system log of the mobile terminal in real time.

According to an aspect of the present disclosure, traffic record on the mobile terminal can be inquired by the user.

According to an aspect of the present disclosure, further comprising: the mobile terminal submitting traffic record information to a server, the server storing the traffic record information into a traffic record database, wherein traffic record on the mobile terminal can be inquired by the user through logging on the server.

According to an aspect of the present disclosure, further comprising: the traffic record information submitted to the server by the mobile terminal including record on traffic consumed by applications in mobile terminals, wherein the record on traffic consumed by various applications in the mobile terminal can be inquired by the user through logging on the server.

According to an aspect of the present disclosure, wherein the synchronization processing of step c) comprises: determining real-time of the data based upon the mobile terminal Internet traffic usage data obtained from the operator, and updating the local mobile terminal Internet traffic usage data monitored by the mobile terminal in real time to real-time Internet traffic usage data.

According to an aspect of the present disclosure, further comprising: determining whether the mobile terminal Internet traffic usage data obtained from the operator is real-time; if it is real-time data, determining that the mobile terminal Internet traffic usage data obtained from the operator is real-time Internet traffic usage data; and if it is not real-time data, based upon a settlement time for the mobile terminal Internet traffic usage data obtained from the operator, adding the local mobile terminal Internet traffic usage data monitored by the mobile terminal after the settlement time to the mobile terminal Internet traffic usage data obtained from the operator, so as to obtain real-time Internet traffic usage data.

According to an aspect of the present disclosure, further comprising: determining a result of the synchronization processing; if the synchronization processing is successful, completing a synchronization update; and if the synchronization processing is not successful, determining that the estimated number of days obtained by the mobile terminal is a number of days remaining in a period, wherein the period is a time interval between adjacent settlement times.

According to an aspect of the present disclosure, further comprising: determining the real-time Internet traffic usage data obtained by the mobile terminal; if a value indicating used traffic for the mobile terminal is equal to or larger than a value indicating total traffic in a package and a value indicating remaining traffic is equal to or less than zero, the estimated number of days is zero; if the value indicating remaining traffic obtained by the mobile terminal is equal to the value indicating total traffic in a package and the value indicating used traffic is equal to zero, a value indicating average used traffic is zero.

According to an aspect of the present disclosure, after the mobile terminal obtaining a value indicating real-time remaining traffic, further comprising: performing a statistical analysis of the amount of time during which the mobile terminal installs and uses the method; if the amount of time is less than m days, determining the result of the synchronization processing; if the amount of time is equal to or larger than m days and equal to or less than n days, the mobile terminal taking traffic used in the amount of time as used traffic and replacing the number of days used in the period with a number of days during which the mobile terminal installs and uses the method; and if the amount of time is larger than n days, the mobile terminal taking the traffic used in the latest n days as used traffic and replacing the number of days used in the period with n, wherein m and n meet 1≦m<n≦31.

According to an aspect of the present disclosure, the mobile terminal using real-time Internet traffic usage data to calculate a predicted number of days with the traffic still being available, including steps of: the mobile terminal performing a statistics of a number of days used and a number of days remaining in the period for a package by using a period and a settlement time for the package; dividing a value indicating used Internet traffic for the mobile terminal by the number of days used in the period for the mobile terminal to obtain a value indicating average used traffic; and dividing the value indicating remaining Internet traffic for the mobile terminal by the value indicating average used traffic to obtain the predicted number of days with the traffic still being available.

According to an aspect of the present disclosure, further comprising: determining a value indicating average used traffic obtained by the mobile terminal; if the value indicating average used traffic for the mobile terminal is zero, the estimated number of days with the traffic still being available for the mobile terminal is the number of days remaining in the period; and if the value indicating average used traffic for the mobile terminal is not zero, the mobile terminal using the real-time Internet traffic usage data to calculate the predicted number of days with the traffic still being available.

According to an aspect of the present disclosure, further comprising: determining the estimated number of days with the traffic still being available using the predicted number of days with the traffic still being available and the number of days remaining in the period obtained by the mobile terminal; if the number of days remaining in the period is less than the predicted number of days with the traffic still being available, the estimated number of days with the traffic still being available for the mobile terminal is the number of days remaining in the period; and if the number of days remaining in the period is equal to or larger than the predicted number of days with the traffic still being available, the estimated number of days with the traffic still being available for the mobile terminal is the predicted number of days.

One solution of the present disclosure relates to a statistical analysis and prompting system for mobile terminal Internet traffic, comprising a communication module, a data inquiry module, a data monitoring module, an information extraction analysis module, a data processing module, a traffic record database, and a prompting module. The communication module is used by a user to communicate with the mobile terminal, and the mobile terminal communicates with a server via the communication module. The data inquiry module is used by the mobile terminal to inquire mobile terminal Internet traffic usage data from an operator in real time, obtain a short message returned from the operator, and submit the short message to the information extraction module, the user inquiring traffic record on the local mobile terminal or the server via the data inquiry module. The data monitoring module is used by the mobile terminal to monitor local mobile terminal Internet traffic usage data in real time. The information extraction analysis module is used to identify a type of the short message and extract traffic usage data from the short message. The data processing module is used by the mobile terminal to perform synchronization processing on the mobile terminal Internet traffic usage data obtained from the operator and the local mobile terminal Internet traffic usage data monitored in real time, in order to obtain real-time Internet traffic usage data, and use the real-time Internet traffic usage data to calculate an estimated number of days with the traffic still being available. The traffic record database is used to save traffic record data for the mobile terminal. The prompting module is used to prompt information regarding the estimated number of days to the user in real time.

According to an aspect of the present disclosure, further comprising a server, wherein the information extraction analysis module is deployed on the server. The server communicates with the mobile terminal via a network connection, receives the short message and extracts traffic usage data, and returns a data result to the mobile terminal.

According to an aspect of the present disclosure, the data processing module comprises a synchronization processing sub-module and a calculating sub-module. The synchronization processing sub-module is used to perform synchronization processing on the mobile terminal Internet traffic usage data obtained from the operator and the local mobile terminal Internet traffic usage data monitored in real time. The calculating sub-module is used to use the real-time Internet traffic usage data to calculate the estimated number of days with the traffic still being available.

Beneficial effects of the present disclosure involve a statistical analysis and prompting method and system for mobile terminal Internet traffic is provided, thus trend analysis can be performed on the data on the Internet traffic already used by the mobile terminal to obtain the estimated number of days for the remaining traffic, and the result can be prompted to the user in real time, so that the user can know the availability of the traffic in time, thereby achieving the objective of reasonably allocating and fully taking advantage of traffic resources. Moreover, the present disclosure facilitates usage and improves experiences for users.

### BRIEF DESCRIPTION OF THE DRAWINGS

In order to clarify embodiments of the present disclosure or solutions in prior art, figures required to be used in the description of embodiments or prior art are explained below. Obviously, the figures described below relate merely to some embodiments of the present disclosure. For one of ordinary skill in the art, other figures can be derived from these figures without creative efforts.

FIG. 1 is a flowchart of a statistical analysis and prompting method for mobile terminal Internet traffic according to an embodiment of the present disclosure.

FIG. 2 is a flowchart of a statistical analysis and prompting procedure for mobile terminal Internet traffic according to an embodiment of the present disclosure.

FIG. 3 is a diagram of a screen for checking traffic in a day of applications by a user through a mobile terminal according to an embodiment of the present disclosure.

FIG. 4 is a diagram of a screen for checking traffic in a month of applications by a user through a mobile terminal according to an embodiment of the present disclosure.

FIG. 5 is a flowchart of a statistical analysis and calculating method for mobile terminal Internet traffic according to an embodiment of the present disclosure.

FIG. 6 is a block diagram of a statistical analysis and prompting system for mobile terminal Internet traffic according to an embodiment of the present disclosure.

### DETAILED DESCRIPTION

In order to clarify the objects, features, and advantages of embodiments of the present disclosure, the present disclosure will be detailed in conjunction with drawings and embodiments.

Embodiments of the present disclosure improve statistical analysis technologies for Internet traffic data in a mobile terminal. A statistical analysis and prompting method for mobile terminal Internet traffic according to an embodiment of the present disclosure can be implemented as follows.

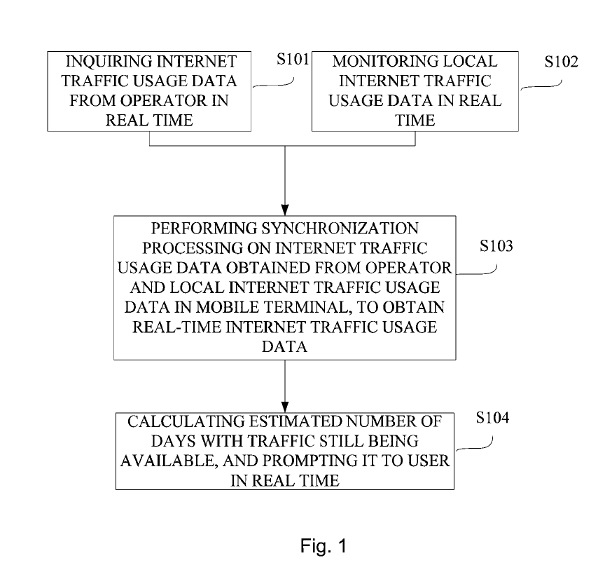

With reference to FIG. 1, the steps comprise:

S101: a mobile terminal obtains mobile terminal Internet traffic usage data from an operator in real time.

S102: the mobile terminal monitors local mobile terminal Internet traffic usage data in real time.

S103: the mobile terminal performs synchronization processing on the mobile terminal Internet traffic usage data obtained from the operator and the local mobile terminal Internet traffic usage data monitored in real time, in order to obtain real-time Internet traffic usage data.

S104: the mobile terminal uses the real-time Internet traffic usage data to calculate an estimated number of days with the traffic still being available, and prompts information regarding the estimated number of days to the user in real time.

In the following, detailed description will be given in conjunction with a specific implementation of embodiments of the present disclosure.

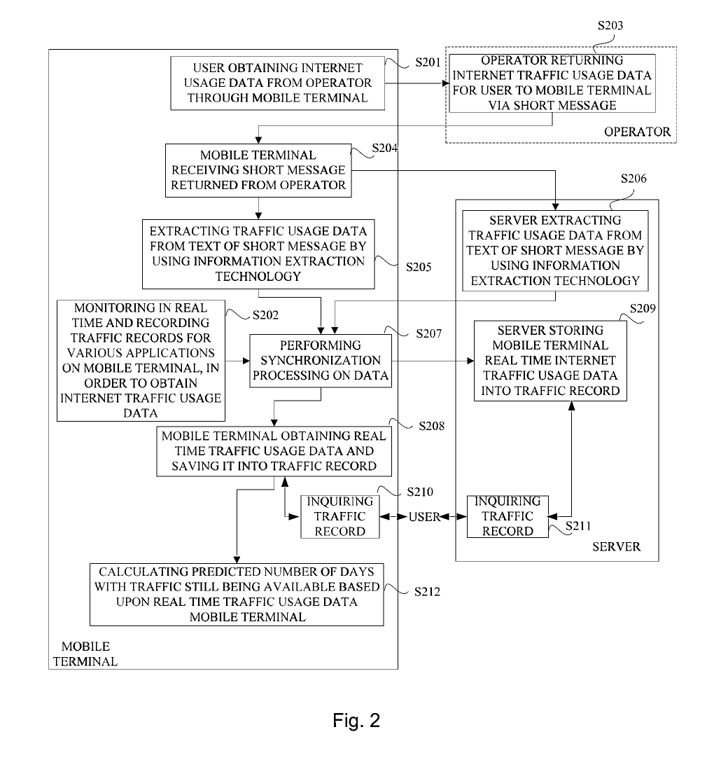

With reference to FIG. 2, a statistical analysis and prompting method for mobile terminal Internet traffic comprises the steps of:

S201: the user may obtain Internet usage data from an operator, such as inquiring the usage data by sending a short message to the operator.

It is noted that the user needs to subscribe a traffic package from the operator before surfing the Internet through use of a mobile terminal. In this embodiment, given that the package subscribed by the user has a total traffic of 50M per month. The usage period is usually a calendar month, beginning with 1^{st} to the last day of the month. If the usage period is not a calendar month, the mobile terminal obtains information on settlement day from information returned from the operator when the Internet traffic usage begins.

S202: the mobile terminal monitors in real time (for example, by accessing a local system log of the mobile terminal in real time) and records traffic record for various applications on the mobile terminal, in order to obtain the local mobile terminal Internet traffic usage data.

Actually, the mobile terminal may surf the Internet by means of GPRS, 3G, WiFi, etc. Monitoring programs may monitor the various applications in real time. Current traffic value is recorded in a system log. However, the ways of handling are different. As for a free of charge access (such as WiFi, etc.), only a real time speed data is displayed and a total amount will not be calculated. As for a chargeable access (such as GPRS, 3G, etc.), a statistics of current traffic value is performed to form Internet traffic usage data. In addition, a statistics of day traffic and month traffic for various applications is performed, and the result is kept in a traffic record.

S203: the operator returns, after receiving the inquiry message from the mobile terminal, Internet traffic usage data for the user to the mobile terminal in the form of a short message.

S204: the mobile terminal receives the short message returned from the operator, where the traffic usage data is embodied as text of the short message. The mobile terminal cannot read digit information directly. For example, the short message reads “dear customer, you have used data traffic of 35.00M until 14:11 Nov. 25, 2011, remaining 15.00M . . . .”

S205: the mobile terminal extracts the mobile terminal Internet traffic usage data from text of the short message by using information extraction technology, and forms the traffic usage data.

S206: the mobile terminal submits the short message to a server after obtaining the short message returned from the operator. The server extracts the digit information from text of the short message so as to form the traffic usage data by using information extraction technology, and returns the traffic usage data to the mobile terminal.

The information extraction technology firstly deletes or identifies invalid portion of the short message, and performs a uniform conversion of the short message. For example, full-width digital symbols are converted to uniform half-width standard digital symbols. Some importance identities (such as date, data, and other importance content features) of the short message are extracted and identified. Words and phrases of the short message are identified and extracted by using “regular expression” and “dictionary plus part of speech”.

Next, valid contents of the short message are resolved as keywords and phrases. The word segmentation algorithm may be reverse maximum matching algorithm which segments words from the end of a sentence in reverse order. Word segmentation employs methods for maximum word group length matching and keyword or key phrase analysis. Apiece of text of a length not exceeding a maximum word group length is cut out to match. If this piece of text is a word, it can be extracted. In the remaining part of the text, the same method is used to segment words.

When a short message is resolved as keywords and phrases, the content of the short message is further identified based upon the keywords and phrases so as to extract key information. In this embodiment, the critical information may be, for example, time information such as “14:11 Nov. 25, 2011”, the key words may include “used data traffic” and “remaining”, and the key data may include “35.00M” and “15.00M”, etc.

Then, the Internet traffic usage data is given which comprises a value indicating total traffic in a user package, a value indicating used traffic, a value indicating remaining traffic, and a settlement time. For example, the Internet traffic usage data may be “remaining traffic in this month: 15M; used traffic: 35M; total traffic in the package: 50M; settlement time: until 14:11 Nov. 25, 2011”.

S207: the mobile terminal performs synchronization processing on the Internet traffic usage data obtained from the operator after receiving the data.

First, it is determined whether the data is real-time. If it is real-time data, the mobile terminal Internet traffic usage data is updated to real-time traffic usage data. If it is not real-time data, based upon the settlement time for the returned data, the local mobile terminal Internet traffic usage data monitored by the mobile terminal after the settlement time is added to the returned data, so as to obtain real-time traffic usage data. Then, the mobile terminal Internet traffic usage data is updated to real-time traffic usage data.

For example, a user sends a short message to the operator for inquiring Internet traffic usage data until 10:00. The operator returns a value indicating used traffic and a value indicating remaining traffic until 10:00. In such case, the data is real time data.

Given that the settlement time for the operator is 9:00 and a user sends a short message to the operator for inquiring Internet traffic usage data until 10:00. The operator returns a value indicating used traffic and a value indicating remaining traffic until 9:00. In such case, the data is not real time data. Therefore, real time data shall be obtained by supplementing Internet traffic usage data monitored by the mobile terminal between 9:00 and 10:00.

S208: the mobile terminal obtains the real time traffic usage data and saves it into a traffic record. The traffic record may include used traffic in a user package, details of day traffic for an application, a ranking list of month traffic, and traffic data for an application being connected to network.

S209: the mobile terminal submits the real time Internet traffic usage data to a server. The server stores the data into a traffic record of the server.

S210: the user may inquire a traffic record on the mobile terminal by checking a traffic monitor record of the mobile terminal.

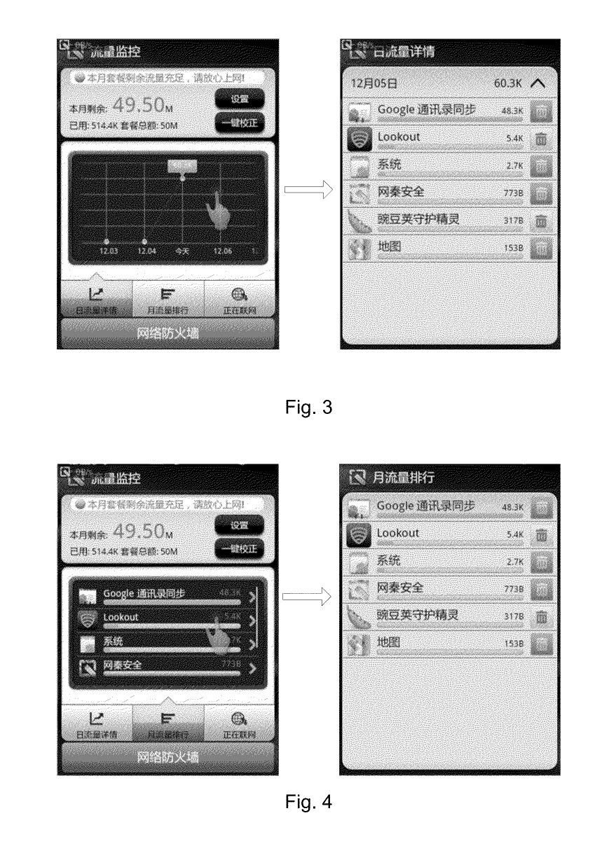

According to this embodiment, as shown in FIG. 3, a user inquires details of day traffic for an application through a mobile terminal. The upper portion of left view of FIG. 3 shows a message prompting “remaining traffic in this month is sufficient, please surfing safely”, and traffic usage data in a user package such as “49.50M remaining in this month, 514.4K used, total traffic in the package: 50M”. The lower portion of left view of FIG. 3 shows an analysis chart of total traffic for a period by the way of a curve. By clicking the curve analysis area, the user may check traffic usage details of traffic usages for various applications that day, as shown in right view of FIG. 3.

According to this embodiment, as shown in FIG. 4, a user inquires a ranking list of month traffic for applications through a mobile terminal. The upper portion of left view of FIG. 4 shows a message prompting “remaining traffic in this month is sufficient, please surfing safely,” and traffic usage data in a user package such as “49.50M remaining in this month, 514.4K used, total traffic in the package: 50M”. The lower portion of left view of FIG. 4 shows traffic usage for all application in this month by the way of a list. By clicking the list analysis area, the user may check traffic usage details of traffic usages for various applications that month, as shown in right view of FIG. 4.

S211: the traffic record on the mobile terminal may be inquired by the user through logging on a server.

It is noted that the mobile terminal submits traffic record information to the server. The server stores the traffic record information into a traffic record database. Then, the traffic record on the mobile terminal may be inquired by the user through logging on a server.

The traffic record information submitted to the server by the mobile terminal includes record on traffic consumed by applications in mobile terminals. The record on traffic consumed by various applications in the mobile terminal can be inquired by the user through logging on the server.

By inquiring the details of traffic usage, the user can understand traffic occupied by various applications which serves as a basis for reasonable usage.

S212: after obtaining the real time traffic usage data, the mobile terminal may calculate the predicted number of days with the traffic still being available based upon the real time traffic usage data.

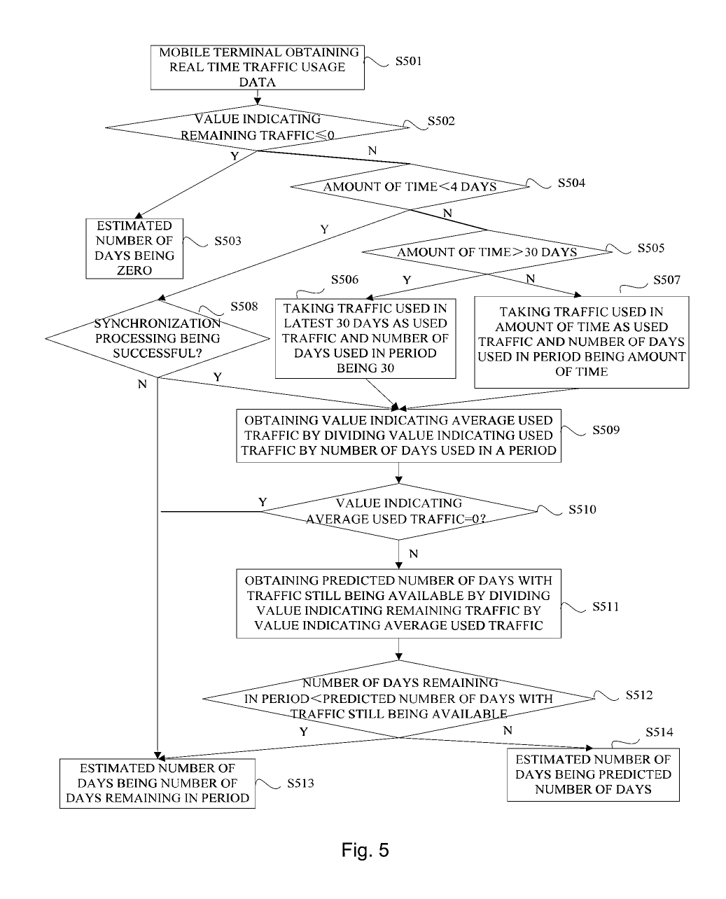

With reference to FIG. 5, the mobile terminal may calculate the predicted number of days with the traffic still being available based upon the real time traffic usage data as follows.

S501: the mobile terminal obtains the real time traffic usage data including a value indicating total traffic in a user package, a value indicating used traffic, a value indicating remaining traffic, and a settlement time.

S502: the mobile terminal determines the value indicating remaining traffic as follows: if the value indicating remaining traffic is equal to or less than zero, it is determined that the used Internet traffic for the mobile terminal is equal to or larger than total traffic in the package. That is, there is no available traffic for the user in the usage period. As shown in S503, the estimated number of days is zero. If the value indicating remaining traffic larger than zero, it is determined that there is available traffic for the user.

Next, the mobile terminal performs a statistical analysis of the amount of time during which the method is installed and used by the mobile terminal as follows.

S504: the mobile terminal determines the amount of time is less than m days. To facilitate understanding, it is assumed that m is 4. If the mobile terminal determines the amount of time is less than 4 days, the result of the synchronization processing will be determined.

If the amount of time is equal to or larger than 4 days, the amount of time needs to be further determined.

S505: the mobile terminal determines whether the amount of time is larger than n days. To facilitate understanding, it is assumed that n is 30. If the amount of time is larger than 30 days, as shown in S506, the mobile terminal takes traffic used in the latest 30 days as the used traffic and replaces the number of days used in the period with 30 days.

If the amount of time is equal to or larger than 4 days and equal to or less than 30 days, as shown in S507, the mobile terminal takes traffic used in the amount of time as the used traffic and replaces the number of days used in the period with the amount of time.

In this embodiment, m and n meet 1≦m<n≦31.

S508: the mobile terminal determines a result of the synchronization processing as follows: if the synchronization processing is successful, the mobile terminal Internet traffic usage data is real time usage data; and if the synchronization processing is not successful, as shown in S513, the estimated number of days obtained by the mobile terminal is the number of days remaining in the period.

S509: the mobile terminal calculates using the real time Internet traffic usage data. First, the mobile terminal uses a usage period and a settlement time for a package, where the period is usually a month. In particular:

total number of days in a period−number of days used in a period=the number of days remaining in a period;

a value indicating used traffic/number of days used in a period=a value indicating average used traffic.

Where, if the value indicating remaining traffic obtained by the mobile terminal is equal to the value indicating total traffic in the package (i.e., the value indicating used traffic is zero), the value indicating average used traffic is zero.

S510: determining the value indicating average used traffic obtained by the mobile terminal as follows:

if the value indicating average used traffic for the mobile terminal is zero, as shown in S513, the estimated number of days with the traffic still being available for the mobile terminal is the number of days remaining in the period;

if the value indicating average used traffic for the mobile terminal is not zero, the mobile terminal uses the real-time Internet traffic usage data to calculate the predicted number of days with the traffic still being available.

S511: the mobile terminal calculate the predicted number of days with the traffic still being available in accordance with the following equation:

the value indicating remaining traffic/the value indicating average used traffic=the predicted number of days with the traffic still being available.

S512: the estimated number of days with the traffic still being available is determined by using the predicted number of days and number of days remaining in the period obtained by the mobile terminal. In particular, if the number of days remaining in the period is less than the predicted number of days with the traffic still being available, the estimated number of days with the traffic still being available for the mobile terminal is the number of days remaining in the period, as shown in S513. If the number of days remaining in the period is equal to or larger than the predicted number of days with the traffic still being available, the estimated number of days with the traffic still being available for the mobile terminal is the predicted number of days.

In this embodiment, the mobile terminal obtains 3 situations for the estimated number of days with the traffic still being available by calculation and comparison: 0, the number of days remaining in the period, and the value indicating remaining traffic divided by the value indicating average used traffic.

Finally, the mobile terminal prompts the estimated number of days with the traffic still being available to the user. For example, it is prompted in a status bar of an interface of the mobile terminal that “the value indicating used traffic/the value indicating remaining traffic, the estimated number of days with the traffic still being available”.

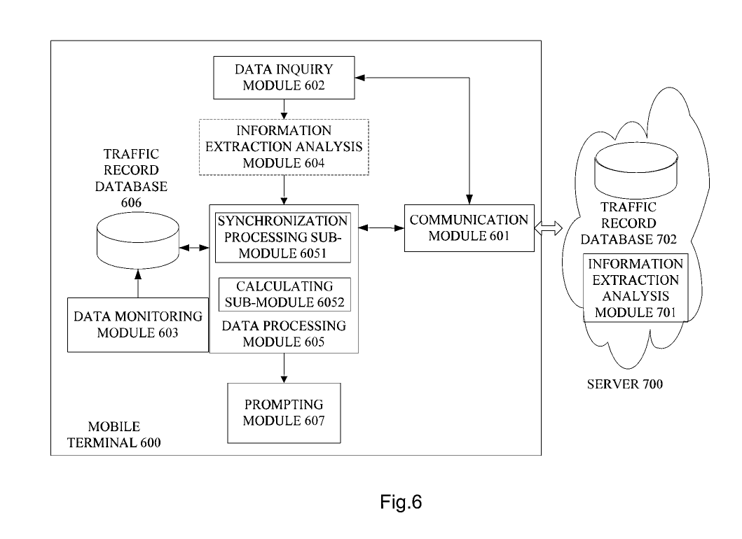

With reference to FIG. 6, a statistical analysis and prompting system for mobile terminal Internet traffic according to an embodiment of the present disclosure is provided. The mobile terminal 600 comprises a communication module 601, a data inquiry module 602, a data monitoring module 603, an information extraction analysis module 604, a data processing module 605, a traffic record database 606, and a prompting module 607. The server 700 comprises an information extraction analysis module 701 and a traffic record database 702.

The communication module 601 is used by a user to communicate with the mobile terminal 600. The mobile terminal 600 communicates with the server 700 via the communication module 601.

The data inquiry module 602 is used by the mobile terminal to inquire mobile terminal Internet traffic usage data from an operator in real time, obtain a short message returned from the operator, and submit the short message to the information extraction module 604 or the information extraction analysis module 701 of the server 700. The user inquires traffic record in the traffic record database 606 of the local mobile terminal 600 or the traffic record database 702 of the server 700 via the data inquiry module 602.

The data monitoring module 603 is used by the mobile terminal to monitor local mobile terminal Internet traffic usage data in real time.

The information extraction analysis module 604 is used to identify the type of the short message and extract traffic usage data from the short message.

The data processing module 605 is used by the mobile terminal 600 to perform synchronization processing on the mobile terminal Internet traffic usage data obtained from the operator and the local mobile terminal Internet traffic usage data monitored in real time, in order to obtain real-time Internet traffic usage data, and use the real-time Internet traffic usage data to calculate the estimated number of days with the traffic still being available.

The traffic record database 606 is used to save traffic record data for the mobile terminal 600.

The prompting module 607 is used to prompt the information regarding the estimated number of days with the traffic still being available to the user in real time.

According to an embodiment of the present disclosure, the system further comprises a server 700. The information extraction analysis module 701 is deployed on the server 700.

The traffic record database 702 is used to save traffic record data submitted by the mobile terminal 600.

The server 700 communicates with the mobile terminal 600 via a network connection, receives a short message and extracts traffic usage data using the information extraction analysis module 701, and returns data result to the mobile terminal 600.

According to an embodiment of the present disclosure, the data processing module 605 comprises a synchronization processing sub-module 6051 and a calculating sub-module 6052. The synchronization processing sub-module 6051 is used to perform synchronization processing on the mobile terminal Internet traffic usage data obtained from the operator and the local mobile terminal Internet traffic usage data monitored in real time. The calculating sub-module 6052 is used to use the real-time Internet traffic usage data to calculate the estimated number of days with the traffic still being available.

The above mentioned and described embodiments are employed herein to illustrate the principles and the effect of the present disclosure, other than limiting the present disclosure. It will be appreciated by the person of skill in the art that various modifications may be made to the above described embodiments without departing from the scope of the present disclosure. Therefore, the scope of the present disclosure should be defined by the appended claims.

What is claimed is:

1. A statistical analysis and prompting method for mobile terminal Internet traffic, comprising the steps of:
a) a mobile terminal obtaining mobile terminal Internet traffic usage data from an operator in real time;
b) the mobile terminal monitoring local mobile terminal Internet traffic usage data in real time;
c) the mobile terminal performing synchronization processing on the mobile terminal Internet traffic usage data obtained from the operator and the local mobile terminal Internet traffic usage data monitored in real time, to obtain real-time Internet traffic usage data;
d) the mobile terminal using the real-time Internet traffic usage data to calculate an estimated number of days with the traffic still being available, and prompting information regarding the estimated number of days to the user in real time.

2. The statistical analysis and prompting method for mobile terminal Internet traffic according to claim 1, wherein the mobile terminal Internet traffic usage data comprises a value indicating total traffic in a user package, a value indicating used traffic, a value indicating remaining traffic, and a settlement time.

3. The statistical analysis and prompting method for mobile terminal Internet traffic according to claim 1, wherein the step a) comprises:
the mobile terminal obtaining a short message including the mobile terminal Internet traffic usage data returned from the operator by sending a short message to the operator.

4. The statistical analysis and prompting method for mobile terminal Internet traffic according to claim 3, further comprising:
the mobile terminal extracting the mobile terminal Internet traffic usage data from text of the short message by using information extraction technology.

5. The statistical analysis and prompting method for mobile terminal Internet traffic according to claim 3, further comprising:
the mobile terminal obtaining the short message returned from the operator and submitting the short message to a server; and
the server extracting the mobile terminal Internet traffic usage data from text of the short message by using information extraction technology, and returning the mobile terminal Internet traffic usage data to the mobile terminal.

6. The statistical analysis and prompting method for mobile terminal Internet traffic according to claim 1, wherein the step b) comprises:
the mobile terminal monitoring mobile terminal Internet traffic usage data in real time by accessing a local system log of the mobile terminal in real time.

7. The statistical analysis and prompting method for mobile terminal Internet traffic according to claim 1, wherein traffic record on the mobile terminal can be inquired by the user.

8. The statistical analysis and prompting method for mobile terminal Internet traffic according to claim 1, further comprising:
the mobile terminal submitting traffic record information to a server, the server storing the traffic record information into a traffic record database;
wherein traffic record on the mobile terminal can be inquired by the user through logging on the server.

9. The statistical analysis and prompting method for mobile terminal Internet traffic according to claim 8, further comprising:
the traffic record information submitted to the server by the mobile terminal including record on traffic consumed by applications in a mobile terminal;
wherein the record on traffic consumed by various applications in the mobile terminal can be inquired by the user through logging on the server.

10. The statistical analysis and prompting method for mobile terminal Internet traffic according to claim 1, wherein the synchronization processing of step c) comprises:
determining real-time of the data based upon the mobile terminal Internet traffic usage data obtained from the operator, and updating the local mobile terminal Internet traffic usage data monitored by the mobile terminal in real time to real-time Internet traffic usage data.

11. The statistical analysis and prompting method for mobile terminal Internet traffic according to claim 10, further comprising:
determining whether the mobile terminal Internet traffic usage data obtained from the operator is real-time;
if it is real-time data, determining that the mobile terminal Internet traffic usage data obtained from the operator is real-time Internet traffic usage data; and
if it is not real-time data, based upon a settlement time for the mobile terminal Internet traffic usage data obtained from the operator, adding the local mobile terminal Internet traffic usage data monitored by the mobile terminal after the settlement time to the mobile terminal Internet traffic usage data obtained from the operator, so as to obtain real-time Internet traffic usage data.

12. The statistical analysis and prompting method for mobile terminal Internet traffic according to claim 10, further comprising:
determining a result of the synchronization processing;
if the synchronization processing is successful, completing a synchronization update; and
if the synchronization processing is not successful, determining that the estimated number of days obtained by the mobile terminal is a number of days remaining in a period, wherein the period is a time interval between adjacent settlement times.

13. The statistical analysis and prompting method for mobile terminal Internet traffic according to claim 1, further comprising:
determining the real-time Internet traffic usage data obtained by the mobile terminal;
if a value indicating used traffic for the mobile terminal is equal to or larger than a value indicating total traffic in a package and a value indicating remaining traffic is equal to or less than zero, the estimated number of days is zero;
if the value indicating remaining traffic obtained by the mobile terminal is equal to the value indicating total traffic in a package and the value indicating used traffic is equal to zero, a value indicating average used traffic is zero.

14. The statistical analysis and prompting method for mobile terminal Internet traffic according to claim 10, wherein after the mobile terminal obtaining a value indicating real-time remaining traffic, further comprising:
performing a statistical analysis of the amount of time during which the mobile terminal installs and uses the method;
if the amount of time is less than m days, determining the result of the synchronization processing;
if the amount of time is equal to or larger than m days and equal to or less than n days, the mobile terminal taking traffic used in the amount of time as used traffic and replacing the number of days used in the period with a number of days during which the mobile terminal installs and uses the method; and
if the amount of time is larger than n days, the mobile terminal taking the traffic used in the latest n days as used traffic and replacing the number of days used in the period with n,
wherein m and n meet 1≦m≦n≦31.

15. The statistical analysis and prompting method for mobile terminal Internet traffic according to claim 10, further comprising:
the mobile terminal using real-time Internet traffic usage data to calculate a predicted number of days with the traffic still being available, including steps of:
the mobile terminal performing a statistics of a number of days used and a number of days remaining in the period for a package by using a period and a settlement time for the package;
dividing a value indicating used Internet traffic for the mobile terminal by the number of days used in the period for the mobile terminal to obtain a value indicating average used traffic; and
dividing the value indicating remaining Internet traffic for the mobile terminal by the value indicating average used traffic to obtain the predicted number of days with the traffic still being available.

16. The statistical analysis and prompting method for mobile terminal Internet traffic according to claim 13, further comprising:
determining a value indicating average used traffic obtained by the mobile terminal;
if the value indicating average used traffic for the mobile terminal is zero, the estimated number of days with the traffic still being available for the mobile terminal is the number of days remaining in the period; and
if the value indicating average used traffic for the mobile terminal is not zero, the mobile terminal using the real-time Internet traffic usage data to calculate the predicted number of days with the traffic still being available.

17. The statistical analysis and prompting method for mobile terminal Internet traffic according to claim 15, further comprising:
determining the estimated number of days with the traffic still being available using the predicted number of days with the traffic still being available and the number of days remaining in the period obtained by the mobile terminal;
if the number of days remaining in the period is less than the predicted number of days with the traffic still being available, the estimated number of days with the traffic still being available for the mobile terminal is the number of days remaining in the period; and
if the number of days remaining in the period is equal to or larger than the predicted number of days with the traffic still being available, the estimated number of days with the traffic still being available for the mobile terminal is the predicted number of days.

18. The statistical analysis and prompting method for mobile terminal Internet traffic according to claim 16, further comprising:
determining the estimated number of days with the traffic still being available using the predicted number of days with the traffic still being available and the number of days remaining in the period obtained by the mobile terminal;
if the number of days remaining in the period is less than the predicted number of days with the traffic still being available, the estimated number of days with the traffic still being available for the mobile terminal is the number of days remaining in the period; and
if the number of days remaining in the period is equal to or larger than the predicted number of days with the traffic still being available, the estimated number of days with the traffic still being available for the mobile terminal is the predicted number of days.

19. A statistical analysis and prompting system for mobile terminal Internet traffic, comprising a communication module, a data inquiry module, a data monitoring module, an information extraction analysis module, a data processing module, a traffic record database, and a prompting module, wherein
the communication module is used by a user to communicate with the mobile terminal, and the mobile terminal communicates with a server via the communication module;
the data inquiry module is used by the mobile terminal to inquire mobile terminal Internet traffic usage data from an operator in real time, obtain a short message returned from the operator, and submit the short message to the information extraction analysis module, the user inquiring traffic record on the local mobile terminal or the server via the data inquiry module;
the data monitoring module is used by the mobile terminal to monitor local mobile terminal Internet traffic usage data in real time;
the information extraction analysis module is used to identify a type of the short message and extract traffic usage data from the short message;
the data processing module is used by the mobile terminal to perform synchronization processing on the mobile terminal Internet traffic usage data obtained from the operator and the local mobile terminal Internet traffic usage data monitored in real time, in order to obtain real-time Internet traffic usage data, and use the real-time Internet traffic usage data to calculate an estimated number of days with the traffic still being available;
the traffic record database is used to save traffic record data for the mobile terminal; and
the prompting module is used to prompt information regarding the estimated number of days with the traffic still being available to the user in real time.

20. The statistical analysis and prompting system for mobile terminal Internet traffic according to claim 19, further comprising a server, wherein the information extraction analysis module is deployed on the server, and wherein the server communicates with the mobile terminal via a network connection, receives the short message and extracts traffic usage data, and returns a data result to the mobile terminal.

21. The statistical analysis and prompting system for mobile terminal Internet traffic according to claim 19, wherein the data processing module comprises a synchronization processing sub-module and a calculating sub-module,
wherein the synchronization processing sub-module is used to perform synchronization processing on the mobile terminal Internet traffic usage data obtained from the operator and the local mobile terminal Internet traffic usage data monitored in real time;
and wherein the calculating sub-module is used to use the real-time Internet traffic usage data to calculate the estimated number of days with the traffic still being available.
